(19) United States
(12) Patent Application Publication
(10) Pub. No.: US 2002/0032871 A1
(43) Pub. Date: Mar. 14, 2002

(54) Method and system for detecting, tracking and blocking denial of service attacks over a computer network

(75) Inventors: Gerald R. Malan, Ann Arbor, MI (US); Farnam Jahanian, Ann Arbor, MI (US)

Correspondence Address: David R. Syrowik, Brooks & Kushman P.C., 1000 Town Center, 22nd Floor, Southfield, MI, 48075-1351, US

(73) Assignee: The Regents of The University of Michigan, Ann Arbor, MI

(21) Appl. No.: 09/855,808

(22) Filed: May 15, 2001

Related U.S. Application Data
(60) Provisional application No. 60/231,479, filed on Sep. 8, 2000.
(60) Provisional application No. 60/231,480, filed on Sep. 8, 2000.
(60) Provisional application No. 60/231,481, filed on Sep. 8, 2000.

(51) Int. Cl. G06F 11/30

(52) U.S. Cl. 713/201

(57) ABSTRACT

A system and method is provided for detecting, tracking and blocking denial of service (“DoS”) attacks, which can occur between local computer systems and/or between remote computer systems, network links, and/or routing systems over a computer network. The system includes a collector adapted to receive a plurality of data statistics from the computer network and to process the plurality of data statistics to detect one or more data packet flow anomalies. The collector is further adapted to generate a plurality of signals representing the one or more data packet flow anomalies. The system further includes a controller that is coupled to the collector and is adapted to receive the plurality of signals from the collector. The controller is constructed and arranged to respond to the plurality of signals by tracking attributes related to the one or more data packet flow anomalies to at least one source, and to block the one or more data packet flow anomalies using a filtering mechanism executed in close proximity to the at least one source.

### CROSS-REFERENCE TO RELATED APPLICATIONS

This application claims the benefit of U.S. provisional application Ser. No. 60/231,479, filed Sep. 8, 2000; U.S. provisional application Ser. No. 60/231,480, filed Sep. 8, 2000; and U.S. provisional application Ser. No. 60/231,481, filed Sep. 8, 2000, all of which are hereby incorporated by reference in their entirety.

### STATEMENT REGARDING FEDERALLY SPONSORED RESEARCH OR DEVELOPMENT

This invention was made with Government support under Contract No. F30602-99-1-0527 awarded by DARPA. The Government has certain rights to the invention.

### BACKGROUND OF THE INVENTION

1. Field of the Invention

The present invention relates generally to data processing systems and more particularly to a method and system for detecting, tracking and blocking denial of service attacks over a local or remote computer network.

2. Background Art

Computer systems are often interconnected into vast computer networks. The computer systems connected on such networks communicate with each other by sending information through their electronic connections. The networks can be organized into various types of topologies. FIG. 1 illustrates one such topology that includes a network 100 having several local area networks 101-102 and that are connected to a routing system 103. The computer systems of each local area network are connected to the communications link 101a-102a. When a source computer system on a local area network 101 or 102 sends information to a destination computer system on the same local area network 101 or 102, the source computer system prepares a packet that includes the address of the destination computer system and transmits the packet on the communications link 101a or 102a. The other computer systems on that same local area network 101 or 102 (i.e., connected to the communications link 101a or 102a) read the packet that was transmitted. The destination computer system detects that its address is included in that packet, and its processes the packet accordingly. Because of geographic and speed considerations, local area networks 101-102 typically only include a limited number of computer systems that are in close proximity. For example, a company with offices in several locations may have a local area network at each location. However, the users of the computer systems may need to send packets to one another regardless to which of local area networks 101-102 the users' computer systems are connected.

To allow packets to be sent from one local area network 101 or 102 to another local area network 101 or 102, routing systems 103 have been developed. A routing system 103 is typically a dedicated special-purpose computer system to which each local area network 101-102 is connected. The routing system 103 maintains a cross-reference between computer system addresses and the local area network 101-102 to which each computer system is connected. The routing system 103 monitors the packets sent on each local area network 101-102 to detect (using the cross-reference) when a computer system on one local area network 101-102 is sending a packet to a computer system on another local area network 101 or 102. When the routing system 103 detects such a packet, it forwards that packet onto the communications link 101a or 102a for the local area network 101 or 102 to which the destination computer system is connected. In this way, the routing system 103 interconnects each of the local area networks 101 and 102 into an overall network 100. Similar routing techniques are used to interconnect networks other than local area networks 101-102. For example, such routing techniques can be used on wide area networks (not shown) and on the Internet 104.

Many different protocols have been developed to allow two computer systems to exchange information. If two computer systems support the same protocol, then they can exchange information. Certain protocols have been tailored to support the exchange of certain types of information efficiently. For example, the Internet protocol (“IP”) was specified by the Department of Defense to facilitate the exchange of information between geographically separated computer systems. The IP specifies a destination in a packet format that identifies source and destination computer systems for data to exchange, but does not specify the format of the data itself. Several additional protocols may be used in conjunction with the IP to specify the format of the data. Two such additional protocols are the transmission control protocol (“TCP”), and the user datagram protocol (“UDP”). TCP and UDP further specify sub-protocols, such as the hyper-text transmission protocol (“HTTP”) and the file transfer protocol (“FTP”), which specify the format of the data of the packet.

FIG. 2 is a diagram illustrating a typical packet sent on a local area network. The packet includes a network routing header followed by protocol specific data. The network routing header may include the destination computer address, the source computer address, and the length of the packet. The protocol specific data includes identification of the protocol and the IP destination address, the IP source address, and the length of the IP portion of the packet. The data portion of the packet contains the sub-protocol identification plus other data of the packet. One specific field of the TCP and UDP sub-protocol is the port number. This port number is used to identify application protocols, which define network services that are available to remote systems.

One problem occurs when a first computer system maliciously sends a flood of packets to a target or second computer system, routing system or network link to overwhelm the reception resources or capacity of the target, which can result in either loss of connectivity to or failure of the target. This flood of packets based attack is commonly known as a denial of service attack (“DoS”).

The most insidious types of DoS attacks occur when the initiator or first computer system hides their origin by forging the source Internet Protocol (IP) address on the attack packets. As a result, administrators and security officers of the target cannot determine the origin of the DoS attack. Further, the administrators and security officers of the target will not likely be able to avoid or shut down the DoS attack.

Conventional routing systems 103 have attempted to avoid DoS attacks by employing various types of packet filtering techniques in the form of firewalls at the entrance to the local area network 101-102. Current implementations of packet filtering permit packets to be delivered to computer systems if the packet's format conforms to access list tables, which include a fixed format. This method is limited to the set of protocols and services defined in the particular access list table. Further, this method does not allow the introduction of different protocols or services which are not specified in the access list table. Finally, while firewall solutions may reduce unauthorized information from accessing a target, the firewall solutions do not reduce the impact that denial of service attacks can have on the availability of the target's bandwidth.

Other packet filtering schemes include a network administrator configuring a routing system 103 to restrict the type and timing of packets that are sent over the network 100. For example, a network administrator may want to restrict packets that are generated by a computer game from being transmitted over the network 100 during normal business hours. A packet for a computer game may be identifiable, for example, by a TCP destination address, that indicates which application on the computer system identified by the IP destination address that is to receive the packet. Thus, the network administrator would configure the routing system 103 to not forward any such packets during normal business hours. Also, the network administrator may want to filter out packets based on their source and destination addresses. For example, a company CEO may only want to receive packets from certain source computer systems and not every computer system on the network 100.

Present known filtering systems, such as packet filtering described above, have often proven either to be ineffective in preventing DoS attacks, or have severely limited access to communication services for communicating with other networks. In general, existing filtering systems disable certain critical communication services between the computer systems that deteriorate inter and intra computer system communications. Moreover, identifying the characteristics related to the DoS attacks can be impractical for network engineers and operators to accomplish by inspection alone, because of the voluminous amount of information associated with the characteristics. Finally, solutions for filtering attack traffic close to the local area network do not affect denial of service attacks that are directed at the heart of a service provider's routing infrastructure, such as attacks on network links or the routing infrastructure directly.

Previously works in this area of technology includes the following:

MCI's DoS Tracker: The DoS tracker's approach was a recursive script that would iterate over a set of routers. Network operators would invoke this script when a DoS attack had already been detected and identified at a specific point in the network (a customer's access router for example). The script would login to a router over its command line interface (CLI), and then turn on debugging. It would then examine the router's debugging output to identify interfaces that were affected by the denial of service attack.

The work was abandoned due to the performance impact caused by using the debugging feature, and the inability to continue the tracking across a network's core.

UUNet's Center Track: The Center Track work involves building a measurement overlay network by building tunnels from each of a network's edge routers to a set of measurement routers. Center Track is only used once an attack is detected by an external tool (or a customer calling on the phone and complaining). All of the target's traffic is off-ramped onto the Center Track overlay network, where its origin can be tracked using direct measurement or router debugging tools.

Network-based Intrusion Detection: Network-based Intrusion Detection (NID) systems are systems that are similar in that they look at a copy of the data in a network and identify malicious attacks. NID systems use passive packet capture techniques to examine the contents of every packet on a network and recreate both transport and application layer information to identify well-known attacks. However, because NID systems detect a wide spectrum of attacks, they do not scale to the highest bandwidth areas, like network service provider networks.

U.S. Pat. No. 4,817,080 to Soha discloses a system that measures traffic statistics by looking at packet contents. The system collects distributed measurements and forwards them to a centralized point.

U.S. Pat. No. 5,781,534 to Perlman et al. discloses apparatus for determining characteristics of a path by utilizing active probing along a network path to determine its characteristics. These characteristics are added to the packet as it traverses the network.

U.S. Pat. No. 5,968,176 to Nessett et al. discloses a system that utilizes many network elements to provide an umbrella countermeasure.

U.S. Pat. No. 5,991,881 to Conklin et al. discloses a system which flags intrusions and updates the status of the intruder's progress. This system only stores the packets with the source address of the attacker.

U.S. Pat. No. 6,078,953 to Vaid et al. discloses a system which classifies packets at the border of the network to provide quality of service. It polices traffic at the edge of the network.

U.S. Pat. No. 6,088,804 to Hill et al. discloses a system which correlates distributed attacks to build a path of the attack through the network. The system uses a training signature for attack identification. That is, the system is trained on attacks, and then compares current activity to this known misuse.

U.S. Pat. No. 6,134,662 to Levy et al. discloses a physical layer security manager for memory-mapped serial communications interface.

Therefore, an unsolved need remains for a system and method for detecting, tracking and blocking DoS attacks which can occur between local computer systems and/or between remote computer systems over a computer network, that overcomes the above-described limitations and deficiencies of the prior art.

### SUMMARY OF THE INVENTION

In accordance with principles of the present invention, a system and method is provided for detecting, tracking and blocking DoS attacks, which can occur between local computer systems and/or between remote computer systems, network links, and/or routing systems over a computer network.

In one embodiment of the present invention, a system includes a collector adapted to receive a plurality of data statistics from the computer network and to process the plurality of data statistics to detect one or more data packet flow anomalies and to generate a plurality of signals representing the one or more data packet flow anomalies. The system further includes a controller which is coupled to the collector. The controller is constructed and arranged to receive and respond to the plurality of signals by tracking attributes related to the one or more data packet flow anomalies to at least one source. The controller is further constructed and arranged to block the one or more data packet flow anomalies using one or more filtering mechanisms executed in close proximity to the at least one source.

The one or more filtering mechanisms can include a plurality of filter list entries, such as access control list entries as well as firewall filter entries, and/or a plurality of rate limiting entries, such as committed access rate (CAR) entries.

In aspect of the present invention, the collector includes a buffer coupled to the computer network and a detector coupled to the buffer. The collector further includes a profiler coupled to the buffer and to the detector. The buffer is adapted to receive and process the plurality of data statistics to generate at least one record that is communicated to the profiler. The profiler processes the record to generate a predetermined threshold. The detector is adapted to receive and process the predetermined threshold and the at least one record to detect if attributes associated with the record exceed the predetermined threshold, which represents the one or more data packet flow anomalies.

The profiler may include means for aggregating the data statistics to obtain a traffic profile of network flows.

The data statistics may be aggregated based on at least one invariant feature of the network flows.

The data statistics may also be aggregated based on temporal, static network and dynamic routing parameters.

The at least one invariant feature may include source and destination endpoints.

The collector further includes a local controller coupled to the detector and to the profiler. The local controller is adapted to receive and respond to the one or more data packet flow anomalies by generating the plurality of signals, which represents the one or more data packet flow anomalies.

The detector includes a database for storing the at least one record, predetermined threshold, the one or more data packet flow anomalies, and related information. Similarly, the profiler includes a database for storing a plurality of data packet flow profiles and related information.

In an aspect of the present invention, the controller includes a correlator coupled to the collector. The correlator is adapted to receive and normalize the plurality of signals representing the one or more data packet flow anomalies. The correlator is further adapted to generate an anomaly table including the attributes related to the one or more data packet flow anomalies. The correlator includes a database for storing the anomaly table. Additionally, the correlator includes an adapter that is constructed and arranged to communicate the anomaly table to a computer device for further processing.

The controller further includes a web server and access scripts that cooperate with the web server to enable the computing device to access the database defined on the controller to view the anomaly table.

In accordance with the present invention, the method for detecting, tracking and blocking one or more denial of service attacks over a computer network includes the steps of collecting a plurality of data statistics from the computer network; processing the plurality of data statistics to detect one or more data packet flow anomalies; generating a plurality of signals representing the one or more data packet flow anomalies; and receiving and responding to the plurality of signals by tracking attributes related to the one or more data packet flow anomalies to at least one source.

The method further includes the step of blocking the one or more data packet flow anomalies in close proximity to the at least one source.

The step of collecting the plurality of data statistics includes buffering the plurality of data statistics; processing the plurality of data statistics to generate at least one record; and receiving and profiling the at least one record to generate a predetermined threshold.

The step of collecting the plurality of data statistics further includes detecting if attributes related to the at least one record exceed the predetermined threshold representing the one or more data packet flow anomalies.

The step of collecting the plurality of data statistics further includes responding locally to the one or more data packet flow anomalies by generating the plurality of signals representing the one or more data packet flow anomalies.

The step of receiving and responding to the plurality of signals includes correlating the plurality of signals representing the one or more data packet flow anomalies; and generating an anomaly table including the attributes related to the one or more data packet flow anomalies.

The step of receiving and responding to the plurality of signals further includes the step of communicating the anomaly table to a computing device for further processing.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a high level block diagram of a conventional computer network system;

FIG. 2 is an exemplary data packet format which can be adapted for communication over the conventional computer network system shown in FIG. 1;

FIG. 3 is a high level block diagram of a computer network system according to one embodiment of the present invention;

FIG. 4 is a partially exploded view of the computer network system shown in FIG. 3;

FIG. 5 is a high level block diagram of the collector shown in FIG. 4;

FIG. 6 is a high level block diagram of the controller shown in FIG. 4; and

FIG. 7 is a high level block diagram exemplifying a DoS attack.

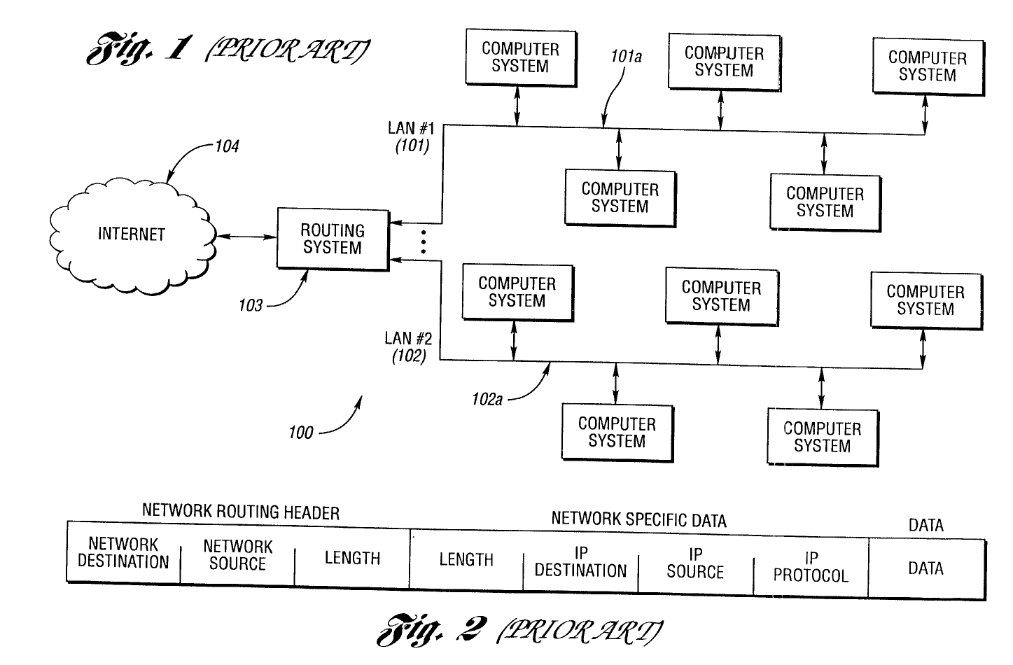

### DETAILED DESCRIPTION OF THE PREFERRED EMBODIMENT(S)

For purposes of illustration and to facilitate a further understanding of the present invention, described below is a reference to an Internet-based computer network system and a method for processing data. However, as understood by one skilled in the art, the present invention is not limited to Internet-based systems and can include systems employing other computer networks as well as stand alone systems.

In accordance with principles of the present invention, a system and method is set forth for detecting, tracking and blocking DoS attacks, which can occur between local computer systems and/or between remote computer systems, network links, and/or routing systems over a computer network.

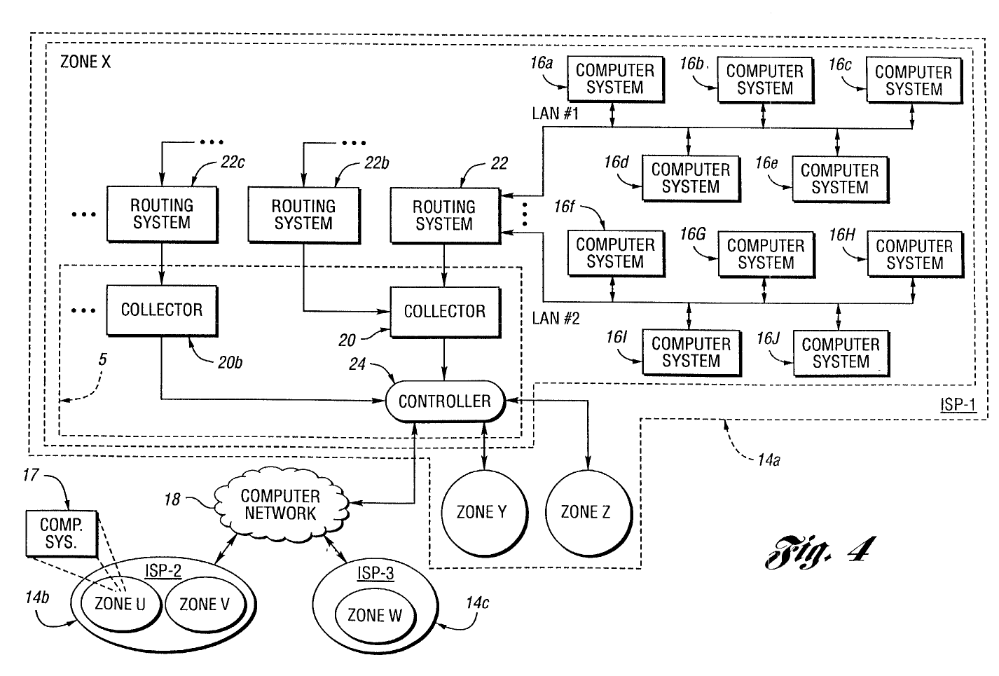

Referring to FIG. 3, a system 5 for detecting, tracking and blocking DoS attacks is incorporated in the computer network system 10 in accordance with one embodiment of the present invention. The system 5 can be located on a single server computer (not shown), which is in communication with components of the computer network system 10 or distributed over a plurality of server computers (not shown), which are also in communication with components of the computer network system 10.

The computer network system 10 includes a plurality of Internet Service Provider computer networks 14a, 14b and 14c (hereinafter ISP computer network(s)”) coupled over a computer network 18. The ISP computer networks 14a, 14b and 14c can also be coupled directly to each other. Each of the ISP computer networks 14a, 14b and/or 14c can include a plurality of computer network zones. As exemplified in FIG. 3, the ISP computer network 14a includes computer network Zone X, Zone Y and Zone Z. The ISP computer network 14b includes computer network Zone U and Zone V. The ISP computer network 14c includes computer network Zone W.

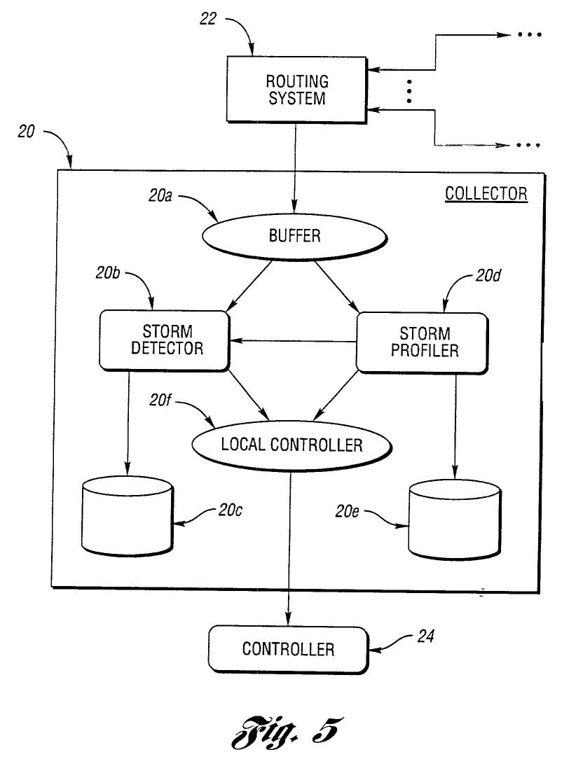

FIG. 4 shows a partially expanded view of the system 5, which is incorporated in the partially expanded view of the computer network system 10. In FIG. 4, Zone X of the ISP computer network 14a includes a number of local area networks (“LAN(s)”) coupled to a central routing system 22. Each LAN is coupled with a plurality of computer systems 16a, 16b, 16c, 16e, 16f, 16g, 16h, 16i and 16j (hereinafter collectively referred to as “computer system(s) 16”). The computer network Zones Y and Z, which are also located on the ISP computer network 14a, can be similarly constructed and arranged as computer network Zones X. Further, the computer network Zones U and V, which are located on the ISP computer network 14b and the computer network Zone W, which is located on the ISP computer network 14c, can also be similarly constructed and arranged as computer network Zones X.

The system 5 includes a collector 20, an optional collector 20b and a zone controller 24. In Zone X, the collector 20 is coupled to the central routing system 22. The collector 20 is further coupled to a zone controller 24, which provides a primary interface to Zone X of the ISP computer network 14a. The computer network Zones Y and Z, which are also located on the ISP computer network 14a can be similarly constructed and arranged as computer network Zone X. Further, the computer network Zones U and V, which are located on the ISP computer network 14b and the computer network Zone W, which is located on the ISP computer network 14c, can also be similarly constructed and arranged as computer network Zones X.

In another embodiment, the collector 20 can be coupled to one or more other router systems, such as the routing system 22b, as exemplified in FIG. 4. In addition, the zone controller 24 can be coupled to one or more other collectors, such as the collector 20b, as also exemplified in FIG. 4. Further, the collector 20b, can be coupled to one or more other routing systems, such as the routing system 22c.

The zone controller 24 located in Zone X of the ISP Computer network 14a provides a primary interface to the computer network Zone Y and to the computer network Zone Z, which are both located on the ISP computer network 14a. The zone controller 24 further provides a primary interface to the computer network Zone U and the computer network Zone V, which are located on the ISP computer network 14b, over the computer network 18. Similarly, the zone controller 24 further provides a primary interface to computer network Zone W, which is located on the ISP computer network 14c, over the computer network 18.

In an embodiment of the present invention, the computer systems 16 located in computer network Zone X of the ISP computer network 14a can each comprise a conventional computer server such as an “NT-Server” which can be provided by Microsoft of Richmond, Wash. or a “Unix Solaris Server” which can be provided by Sun Micro Systems of Palo Alto, Calif. These computer systems 16 can be programmed with conventional Web-page interface software such as: “Visual Basic”, “Java”, “JavaScript”, “HTML/DHTML”, “C++”, “J+”, “Perl” or “Perlscript”, or “ASP”. These computer systems can further be programmed with an operating system, Web server software, Web Application software, such as an e-commerce application and computer network interface software.

Each of the routing systems 22, 22b and 22c, as shown in FIG. 4, can be a conventional router, such as a “Cisco 12000”, available from Cisco Corporation of San Jose, Calif. Further, each of the routing systems can be adapted to run data packet flow statistical software, such as Netflow™ software, also available from Cisco Corporation of San Jose, Calif. Alternatively, each of the routing systems, as shown in FIG. 4, can be another conventional router, such as an “M-40”, available from Juniper Corporation of Sunnyvale, Calif. Further, each of the routing systems can be adapted to run data packet flow statistical software, such as Juniper Cflowd™ software, also available from Juniper Corporation of Sunnyvale, Calif. The packet flow statistical software running on each of the routing systems 22, 22b and 22c enable each of the routing systems 22, 22b and 22c to gather and store data packet flow statistical information. The data packet flow statistical information can include the number of packets which have been communicated between computer systems 16, the duration of communication between each of the computer systems 16, the total number of packets communicated over each LAN (which is typically used for capacity planning) as well as other various data packet flow statistical information.

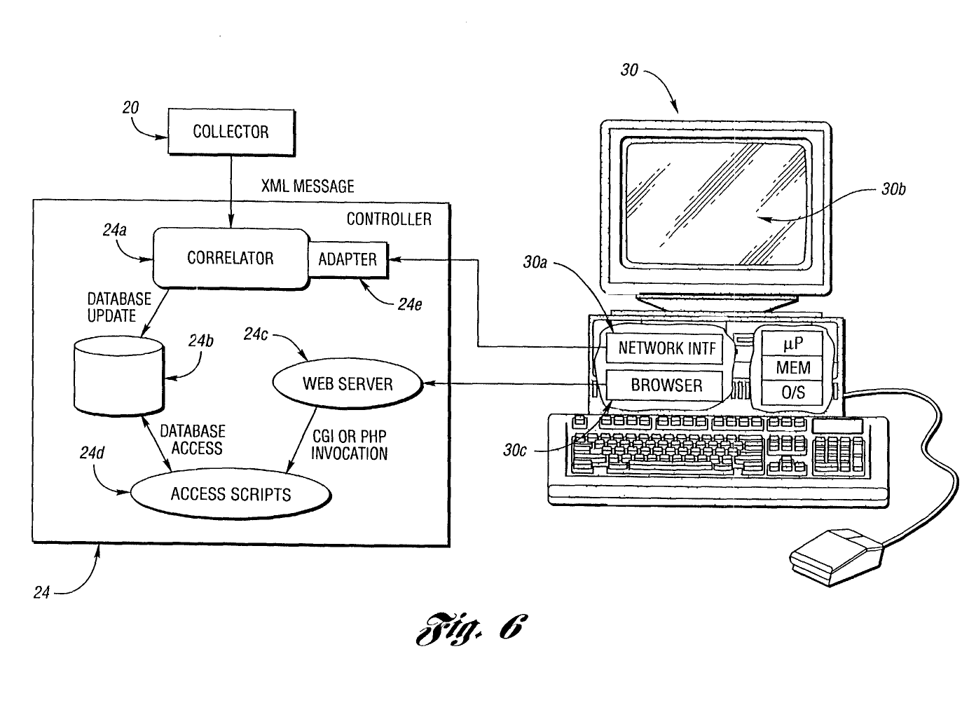

FIG. 5 shows the collector 20 in detail. The collector includes an input buffer 20a coupled to the routing system 22. The input buffer is coupled to a storm detector 20b and to a storm profiler 20d. The storm detector 20b includes a detector database and the storm profiler 20d includes a profiler database 20e. The collector 20 further includes a local controller 20f, which is coupled to the storm detector 20b and to a storm profiler 20d. The local controller 20f is further coupled to the zone controller 24.

The collector 20 is adapted to receive the data packet flow statistical information from the routing system 22 and to process the data packet flow statistical information to detect data packet flow anomalies. The collector 22b of Zone X, as well as other various collectors (not shown), which are included in the other various Zones U, V, W, Y and Z are similarly constructed and arranged as the collector 20 of Zone X.

The input buffer 20a, located on collector 20, is adapted to normalize or categorize the data packet flow statistical information and to generate a number of records including the normalized data packet flow statistical information. The storm detector 20b is adapted to detect the data packet flow anomalies by comparing the records to an anomaly pattern and/or a predetermined threshold. If components of the normalized data packet flow statistical information exceed the predetermined threshold, a data packet flow anomaly is detected. Thereafter, the detected data packet flow anomaly and data associated with the data packet flow anomaly, such as the source and destination addresses of the flow information can be stored in the detector database 20c.

The storm profiler module 20d is adapted to receive the normalized data packet flow statistical information or records from the input buffer 20a and to generate the predetermined threshold, which is concomitantly communicated to the storm detector module 20b. In this configuration, the predetermined threshold defined in the storm detector is adaptively adjusted based on changing trends or profiles of the normalized data packet flow statistical information received by the storm profiler 20d. The changing trends or profiles of the normalized data packet flow statistical information, for example, can include changes in the average bandwidth allocated to each of the computer systems 16 during a particular period of time or changes to the number of computer systems 16 communicating information at the same instant of time.

The local controller 20f, which is coupled to both the storm detector 20b and to the storm profiler 20f, is adapted to receive the data packet flow anomaly from the storm detector 20b, as well as data associated with the data packet flow anomaly, as previously described. After receiving the data packet flow anomaly and the associated data from the storm detector, the local controller 20f generates a signal or an alert message. The alert message can include pertinent information related to the anomaly. The pertinent information related to the anomaly can include the characteristics of the anomaly, the source and destination of the anomaly, the protocols involved and their sub-protocols, the detection mechanism used to identify the anomaly, the predetermined threshold, routing systems in the path of the anomaly, as well as the magnitude or severity of the anomaly. The alert message is communicated to the zone controller 24 to enable the zone controller 24 to further process the alert message and to enable the zone controller 24 to communicate the alert message to other Zones U, V, W, X, Y and Z and/or ISPs 14b and 14c.

In an embodiment, the collector takes samples of several types of statistics, which are obtained by the router 22, such as single packet statistics and flow-based statistics. Single packet statistics provide essential information about a set of packets entering a forwarding node or router 22. Some of the single packet statistics can include: destination and source IP addresses, incoming interface, protocol, ports, and length. After collection of these single-packet statistics, the collector can process the statistics as described above to adaptively adjust the predetermined threshold defined in the storm detector, which detects the packet anomalies.

Flow-based statistics include a set of packets that are related to the same logical traffic flow. The concept of flow-based statistics is generally defined as a stream of packets that all have the same characteristics, such as, source address, destination address, protocol type, source port, and destination port. The flow-based statistics may be either uni-directional or bidirectional. Single-packet statistics can be aggregated to generate a single flow-based statistic. An example of the single flow-based statistic can include a flow duration, number of packets included over a predetermined duration, mean bytes per packet, etc.

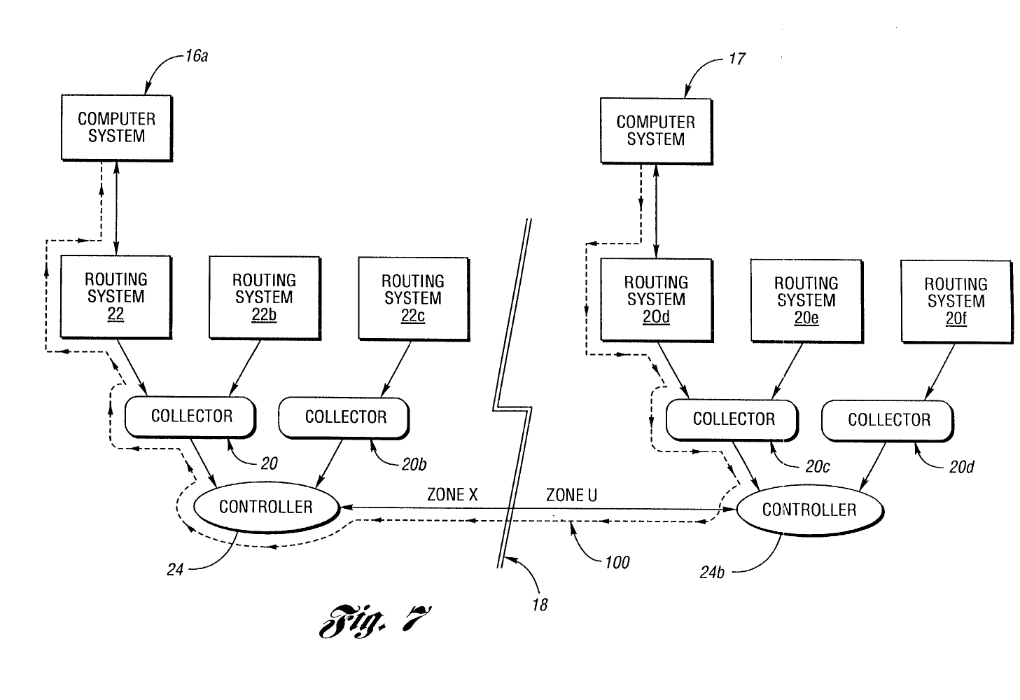

Referring further to FIG. 6, the zone controller 24 includes a correlator 24a coupled to the collector 20. The correlator 24a includes a communication interface adapter 24e. The zone controller 24 further includes an alert message database 24b, which is coupled to the correlator module 24a. A web server 24c and access scripts software 24d are also defined on the controller 24.

The zone controller 24 is adapted to receive a plurality of alert messages from the collector 20, and to process the alert messages by aggregating the alert messages based on the pertinent information related to the anomaly, as described above. The zone controller 24 of Zone X, as well as other various controllers (not shown), which are included in the other various Zones U, V, W, Y and Z are similarly constructed and arranged as the controller 24 of Zone X.

More precisely, the correlator 24a is adapted to receive and categorize the alert messages and to generate a number of tables including the categorized alert messages. The tables including the categorized alert messages are stored in the alert message database 24b, which is coupled to the correlator module 24a. The correlator module 24a is further adapted to compare the alert messages to determine if trends exist. One example of a trend can be a plurality of alert messages that are traceable through the computer network system 10 to a particular computer system 16. Another example of trend can be a plurality of alert messages that include similar characteristics.

The communication interface adapter 24e operates to provide a communication interface to an external computer device 30, such as a notebook computer, desktop computer, server or personal digital assistant (“PDA”). The personal computing device 30 can be adapted to run network management interface software 30a, such as HP Openview™, which can be obtained from Hewlett-Packard Company of Palo Alto, Calif. The network management interface software 30a is adapted to interface with the alert message database 24b and to provide a graphical user interface (“GUI”) on the display 30b of the computing device 30. Thereafter, a network administrator can view and respond to the alert messages.

Alternatively, the personal computing device 30 can include a conventional web browser 30c, which is similarly adapted to interface with the alert message database 24b via a web server 24c and access scripts module 24d and to provide a graphical user interface (“GUI”) on the display 30b of the computing device 30. Similar to that described above, the network administrator can view and respond to the alert messages.

Once the controller has received the alert message from the collector 20, the controller 24 can apply several approaches to trace the DoS attack back to its origin, such as, directed tracing or distributed correlation. In directed tracing, information related to the computer network system topology is processed to work backwards towards the source or origin of the DoS attack. Directed tracing relies on the fact that both the router system's incoming interface statistic for a DoS attack and information related to the computer network system 10 topology are known to determine what routers are upstream on a particular link that carried the DoS attack packet. With this knowledge, upstream routers (not shown) can then be queried for their participation in transiting the attack packet. It is useful to note that since these upstream routers are looking for a specific attack signature, it is much easier to find the statistics related to the attack packet.

In distributed correlation, the controller 24 compares the attack signature or characteristic information related to the DoS attack with similar information detected at other routers 22b and 22c in the computer network system 10. DoS attack signatures that substantially match are grouped and implicitly form the path from the source of the DoS attack to the target. This contrasts with the directed tracing approach, as previously described, where a general attack profile is extracted from every router's statistics to uncover the global path for the DoS attack packet.

After detection and tracing of the DoS attack packet, the controller 24 blocks DoS attacks as close to their Source as possible. By taking a global view of the ISP computer networks 14a, 14b and 14c, the controller 24 is able to coordinate the configuration of the routing systems 22, 22b and/or 22c to filter certain types of traffic by employing either custom filtering hardware (not shown) or filtering mechanisms included in the routing systems. The custom filtering hardware can be incrementally deployed in tile network. Example filtering mechanisms can include Access Control List entries (“ACLs”), and Committed Access Rate (“CAR”) limiters, which can be provided by Cisco Systems Corporation of San Jose, Calif. An example of filtering hardware can include Internet Processor 11, which can be provided by Juniper Networks Corporation of Sunnyvale, Calif., which can be utilized to download coarse-grained filters that will remove unwanted DoS attacks in real-time.

Referring again to FIG. 4, in one specific example, a DoS attack from a computer system 17 located in Zone U of ISP computer network 14b to one specific computer system 16a of Zone X can be detected, tracked and blocked by the system 5 of the present invention.

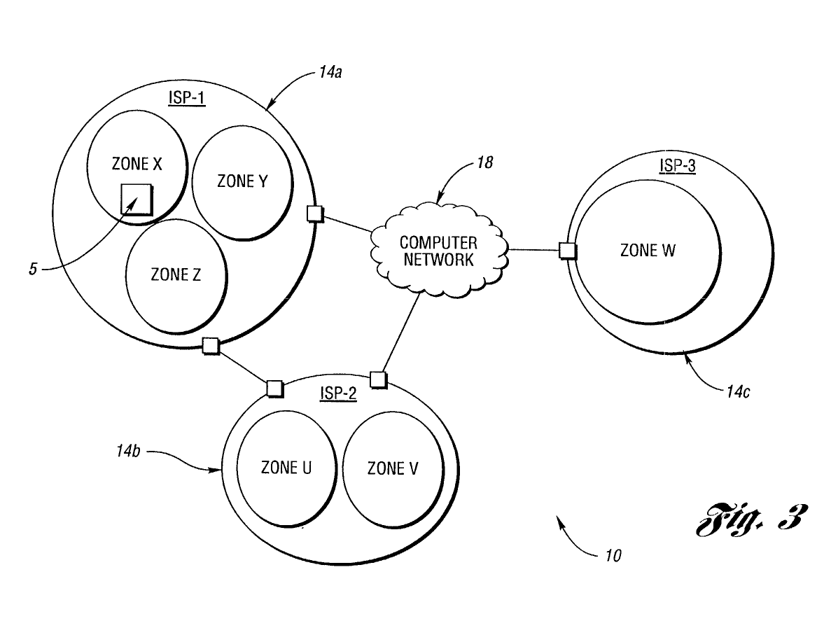

In this example, the DoS attack executed by the computer system 17 includes a SYN-packet flood DoS attack with spoofed source addresses. SYN-packets are TCP/IP packets that initiate data transfer sessions. As such, a SYN-packet flood denies legitimate traffic access to the targeted computer system 16a, because it uses up available bandwidth and consumes predefined computer system 16a resources. A spoofed source addresses is one in which the attacking computer system 17 hides it actual computer network location from the targeted computer system 16a by forging the return address on the TCP/IP data packet (FIG. 2). This makes it difficult to identify the source of the traffic when examining forensic data at the targeted computer system 16a.

Referring further to FIG. 7, the specific trajectory of the SYN-packet flood attack from the computer system 17 of Zone U located in the ISP-2 computer network 14b to computer system 16a of Zone X located in the ISP-1 computer network 14a is illustrated by the DoS attack path 100. The DoS attack path 100 commences at the attacking computer system 17 and extends through the routing system 22d, through the collector 20c, through the controller 24b, through the computer network 18, through the controller 24, through the collector 20, through the routing system 22 and to the targeted computer system 16a.

After the SYN-packets flow through the routing system 22, the routing system 22 generates flow statistics, which are exported to the collector 20. These flow statistics describe the traffic flow characteristics between computer system 17 (DoS attacker) and the computer system 16a (target of DoS attack). The SYN-packet flood attack is represented in these exported flow statistics as the computer system 16a receiving an unusually high number of TCP sessions. This anomalous traffic is detected at the collector 20 and an alert message is communicated to the controller 24. After the controller 24 receives the alert message, it schedules a periodic sampling of anomaly statistics from collector 20, which can be represented by a pair of request and reply messages communicated between the collector 20 and the controller 24.

Referring again to FIG. 5, during this SYN-packet flood attack, the collector 20 collects flow statistics related to the SYN-packets and stores the flow statistics in the buffer 20a, which is located on the collector 20. The buffer 20a normalizes the incoming flow-statistics to form records. The records are places into a shared table. The storm detector module 20b analyzes the records in this shared table and detects anomalous traffic. In this example, the storm detector 20b detects the pattern of records as a SYN-packet flood attack, because the number of records exceeds a predetermined threshold defined on the storm detector 20b. The storm profiler 20d also analyzes the records and based on this analysis, the storm profiler 20d adaptively adjusts the predetermined threshold defined on the storm detector 20b. After detecting the SYN-packet flood attack, the storm detector 20b sends an alert message along with a signature (e.g. a fingerprint of the alert) to the local controller 20f. The local controller 20f adds the signature of the alert to a table in memory, which represents the on-going local anomalies. When one of these local ongoing anomalies reaches a significant level of interest (e.g. a second predetermined threshold), such as a long duration or high severity, the local controller 20f notifies an anomaly-profiler module (not shown) to add a new anomaly to the set of current-anomalies that it measures. Thereafter, the anomaly-profiler module analyzes the normalized flow statistics in buffer 20a that are related to the anomaly and begins to collect long-term statistics about the anomaly. Furthermore, the anomaly-profiler places periodic snapshots of these long-term statistics into the storm profiler database 20e, which is located on the collector 20. At the same time, the local controller forwards the alert to the controller 24 as an alert message. The controller 24 can periodically request updated anomaly information, which in this example relates to a SYN-packet flood attack, from the local controller 20. The local controller 20 can respond by providing the controller 24 with the most recently collected long-term statistics related to the anomaly.

As shown in FIG. 6, the specific operation of the controller 24 includes receiving the alert messages, anomaly fingerprints and anomaly statistical summaries from the collector 20 at the correlator 24a located on the controller 24. Upon receipt of the alert message from collector 20, the correlator 24a schedules a periodic request for updated anomaly statistical summaries. The correlator 24a translates the updated anomaly statistical summaries and correlates their features using attributes in the anomaly fingerprint to identify system-wide anomalies. These controller-specific anomaly statistics are then translated into system-wide representation anomalies, which are subsequently stored in the database 24b.

In the SYN-packet flood based attack example, the correlator 24a located on the controller 24 sends a simple network management protocol (“SNMP”) alert message to the network management interface 30a located on the personal computing device 30. This alert message notifies the network administrator and/or security operators as to the presence of the SYN-packet based flood attack. Included in this alert message is the network address, such as the universal resource locator (“URL”) that describes the anomaly's location in the database 24b of the controller 24. The network management interface 30a can share the URL associated with the SYN-packet based flood attack with the web browser 30c also located on the personal computing device 30. The browser 30c can use a hyper text transfer protocol (“HTTP”) type transfer using the URL to visualize the statistics related to the SYN-packet based flood attack, and to generate ACL and CAR entries for remediation of the SYN-packet based flood attack When the web server 24c receives the URL from the browser 30c, the web server 24c invokes server-side access scripts 24d, which generates queries to the database 24b for generating a dynamic HTML web page. The network administrator and/or security operators can view the SYN-packet based flood attack anomalies on the web page, which is displayed on the display 30b of the computing device 30.

Although not shown, in an embodiment, the system 5 for detecting, tracking and blocking denial of service attacks can be located on a removable storage medium. The removable storage medium can be transported and selectively loaded onto the routing systems 22, 22b and/or 22c. Alternatively, the system 5 for detecting, tracking and blocking denial of service attacks can be partially located on the routing systems 22, 22b and/or 22c and partially located on other servers (not shown). For example, the collector 20 can be located on routing system 22 and the collector 20b can be located on routing system 22c. Further, zone controller 24 can be co-located with either the collector 20, the collector 20b, or , zone controller 24 can be located on another server (not shown).

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A system for detecting, tracking and blocking one or more denial of service attacks over a computer network, the system comprising:
a collector adapted to receive a plurality of data statistics from the computer network and to process the plurality of data statistics to detect one or more data packet flow anomalies and to generate a signal representing the one or more data packet flow anomalies; and
a controller coupled to the collector to receive the signal;
wherein the controller is constructed and arranged to respond to the signal by tracking attributes related to the one or more data packet flow anomalies to at least one source, and wherein the controller is constructed and arranged to block the one or more data packet flow anomalies.

2. The system of claim 1, wherein the collector includes a buffer coupled to the computer network and being adapted to process the plurality, of data statistics to generate at least one record.

3. The system of claim 2, wherein the collector further includes a profiler coupled to the buffer and being adapted to receive and process the record to generate a predetermined threshold.

4. The system of claim 3, wherein the profiler includes means for aggregating the data statistics to obtain a traffic profile of network flows.

5. The system of claim 4, wherein the data statistics are aggregated based on at least one invariant feature of the network flows.

6. The system of claim 4, wherein data statistics are aggregated based on temporal, static network and dynamic routing parameters.

7. The system of claim 5, wherein the at least one invariant feature includes source and destination endpoints.

8. The system of claim 3, wherein the collector further includes a detector coupled to the buffer and to the profiler, the collector being adapted to receive and process the record and the predetermined threshold to detect if attributes associated with the record exceed the predetermined threshold representing the one or more data packet flow anomalies.

9. The system of claim 8, wherein the collector further includes a local controller coupled to the detector and to the profiler and being adapted to receive and respond to the one or more data packet flow anomalies by generating the signal representing the one or more data packet flow anomalies.

10. The system of claim 9, wherein the detector includes a database for storing the at least one record, predetermined threshold, the one or more data packet flow anomalies, and related information.

11. The system of claim 10, wherein the profiler includes a database for storing a plurality of data packet flow profiles and related information.

12. The system of claim 1, wherein the controller includes a filtering mechanism for blocking the one or more data packet flow anomalies.

13. The system of claim 12, wherein the filtering mechanism includes a plurality of filter list entries.

14. The system of claim 12, wherein the filtering mechanism includes a plurality of rate limiting entries.

15. The system of claim 1, wherein the controller includes a correlator coupled to the collector and being adapted to receive and normalize the plurality of signals representing the one or more data packet flow anomalies and to generate an anomaly table including the attributes related to the one or more data packet flow anomalies.

16. The system of claim 15, wherein the correlator includes a database for storing the anomaly table.

17. The system of claim 16, wherein the correlator further includes an adapter that is constructed and arranged to communicate the anomaly table to a computing device for further processing.

18. The system of claim 16, wherein the controller further includes:
a web server; and
access scripts that cooperate with the web server to enable the computing device to access the database defined on the controller to view the anomaly table.

19. A system comprising:
at least one routing system;
a plurality of computer systems coupled to the routing system; and
means for detecting one or more denial of service attacks communicated to the plurality of computer systems over the at least one routing system.

20. The system of claim 19, further including a means for tracking the one or more denial of service attacks communicated to the plurality of computer systems over the at least one routing system.

21. The system of claim 20, further including a means for blocking the one or more denial of service attacks communicated to the plurality of computer systems over the at least one routing system.

22. The system of claim 21, wherein the means for detecting includes a means for collecting a plurality of data statistics from the at least one routing system.

23. The system of claim 22, wherein the means for detecting further includes a means for processing the plurality of data statistics to detect one or more data packet flow anomalies.

24. The system of claim 23, wherein the means for detecting further includes a means of generating a plurality of signals representing the one or more data packet flow anomalies.

25. The system of claim 24, wherein the means for tracking includes a means for receiving and responding to the plurality of signals by tracking attributes related to the one or more data packet flow anomalies to at least one source.

26. The system of claim 19, further including a means for communicating the one or more denial of service attacks to a computing device for further processing.

27. A method for detecting, tracking and blocking one or more denial of service attacks over a computer network, the system comprising the steps of:
collecting a plurality of data statistics from the computer network;
processing the plurality of data statistics to detect one or more data packet flow anomalies;
generating a plurality of signals representing the one or more data packet flow anomalies; and
receiving and responding to the plurality of signals by tracking attributes related to the one or more data packet flow anomalies to at least one source.

28. The method of claim 27, further including the step of blocking the one or more data packet flow anomalies in close proximity to the at least one source.

29. The method of claim 28, wherein the step of collecting the plurality of data statistics includes:
buffering the plurality of data statistics;
processing the plurality of data statistics to generate at least one record; and
receiving and profiling the at least one record to generate a predetermined threshold.

30. The method of claim 29, wherein the step of collecting the plurality of data statistics further includes;
detecting if attributes related to the at least one record exceed the predetermined threshold representing the one or more data packet flow anomalies.

31. The method of claim 30, wherein the step of collecting the plurality of data statistics further includes:
responding locally to the one or more data packet flow anomalies by generating the plurality of signals representing the one or more data packet flow anomalies.

32. The method of claim 27, wherein the step of receiving and responding to the plurality of signals includes:
correlating the plurality of signals representing the one or more data packet flow anomalies; and
generating an anomaly table including the attributes related to the one or more data packet flow anomalies.

33. The method of claim 32, wherein the step of receiving and responding to the plurality of signals further includes the step of communicating the anomaly table to a computing device for further processing.
